(19) United States
(12) Patent Application Publication
(10) Pub. No.: US 2014/0297988 A1
(43) Pub. Date: Oct. 2, 2014

(54) STORAGE DEVICE, ALLOCATION RELEASE CONTROL METHOD

(71) Applicant: FUJITSU LIMITED, Kawasaki-shi (JP)

(72) Inventors: Takahiro OHYAMA, Kawasaki (JP); Akihito KOBAYASHI, Kawasaki (JP); Motohiro SAKAI, Yokohama (JP)

(73) Assignee: FUJITSU LIMITED, Kawasaki-shi (JP)

(21) Appl. No.: 14/181,762

(22) Filed: Feb. 17, 2014

(30) Foreign Application Priority Data
Mar. 28, 2013 (JP) 2013-070672

(51) Int. Cl. G06F 12/02

(52) U.S. Cl. CPC G06F 12/0223
USPC 711/170

(57) ABSTRACT

A storage device that allocates an unused physical storage area to logical storage areas to which write has been requested by an upper device, the storage device including a pattern test unit that tests whether a data pattern written to each of the logical storage areas is a data pattern indicating that allocation of the physical storage area is needed, a skip control unit that determines a skip object for which the pattern test unit does not perform the test among the logical storage areas being test objects of the pattern test unit, and excludes the skip object from the test objects, and a release control unit that releases allocation of a physical storage area to a logical storage area, tested by the pattern test unit, to which the data pattern indicating that allocation of the physical storage area is not needed.

### CROSS-REFERENCE TO RELATED APPLICATION(S)

This application is based upon and claims the benefit of priority of the prior Japanese Patent Application No. 2013-070672, filed on Mar. 28, 2013, the entire contents of which are incorporated herein by reference.

### FIELD

The embodiment discussed herein is related to a storage device, an allocation release control method.

### BACKGROUND

As one technique that effectively manages an amount storage device, thin provisioning technique is known. Thin provisioning is a technique that virtually allocates a logical storage area (logical area) on an upper device such as a server and allocates a physical storage area (physical disk area) constructed by memory devices such as magnetic disks in a timing when a physical storage area is actually needed. By utilizing thin provisioning function, operation can be started with a small number of physical disks and it is allowed to add physical disks as the need arises. Thus, a system administrator can reduce initial cost and improve use efficiency of disks.

A logical area that is virtualized (logically allocated) by the thin provisioning function is called Thin Provisioning Volume (TPV). A unit logical area for control obtained by dividing a TPV into blocks each having a certain logical block size is herein called a chunk. Note that the size of a chunk of this type is set between several hundred kilobytes to several hundred megabytes.

When an upper device such as a host writes data to a TPV, a preferable physical disk area corresponding to the amount that the host has written is allocated for each chunk. Then, data is written to the physical disk area that has been allocated to the logical area. Right after formation of a TPV by thin provisioning function, a physical disk area is not allocated for any chunk.

Upon initialization of a TPV or upon restore of backup by a host OS (Operating System), all-zero data may be written as data indicating an unused portion. Here, “all-zero data” is data of all zero.

When all-zero data is written to a chunk, a physical disk area is undesirably allocated for a logical area for which allocation is not needed. Therefore, there is an autonomous function of releasing allocation of a physical disk area corresponding to a logical area for which the physical disk area is allocated and of which data is all-zero data and of returning the physical disk area to a storage pool. Here, a storage pool is used to gather and control physical disk areas that are not allocated for any logical area.

There is a conventional technique that backs up a chunk with default data in an area for which a physical storage is not allocated and then prevents allocation of a physical storage for the area upon restore in a storage system having a dynamic chunk allocation function. In addition, an LSI circuit that checks whether data is default is disclosed.

In addition, there is a conventional technique that checks whether a real storage area is allocated to each of blocks included in a virtual volume upon copy of a stored content of the virtual volume and then releases any block to which a real storage area is not allocated. Related-art examples are described in Japanese Laid-open Patent Publication No. 2008-130080, Japanese Laid-open Patent Publication No. 2011-076572.

However, a storage device is not capable of effectively releasing a physical disk area allocated to a logical area for which allocation of a physical disk area is not actually needed, which is an issue. More specifically, in order to skip allocation of a physical disk area, a check whether data in a logical area is all zero is preferred. However, for this check, all data of the logical area has to be read from disks, and thus a check whether data is all zero is time consuming. In addition, when a check whether data is all zero is performed using an LSI circuit, cost is increased.

### SUMMARY

According to an aspect of an embodiment, a storage device includes a pattern test unit that tests whether a data pattern written to each of the logical storage areas is a data pattern indicating that allocation of the physical storage area is needed, a skip control unit that determines a skip object for which the pattern test unit does not perform the test among the logical storage areas being test objects of the pattern test unit, and excludes the skip object from the test objects, and

a release control unit that releases allocation of a physical storage area to a logical storage area, tested by the pattern test unit, to which the data pattern indicating that allocation of the physical storage area is not needed.

According to another aspect of an embodiment, an allocation release control method includes allocating, to a plurality of logical storage areas to which write has been requested by an upper device, an unused physical storage area from a whole physical storage area constructed by one or more memory devices, performing a test whether a data pattern written to each of the logical storage areas is a data pattern indicating that allocation of the physical storage area is needed, after determining a skip object for which the test is not performed, while excluding the logical storage area that has been determined to be a skip object, and releasing allocation of a physical storage area, tested by the performing, to a logical storage area to which the data pattern indicating that allocation of the physical storage area is not needed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a storage system according to an embodiment;

FIG. 2 is a diagram illustrating a hardware configuration of a CM;

FIG. 3 is a functional block diagram illustrating functions realized by executing firmware;

FIG. 4 is a flowchart illustrating a flow of allocation release processing of a release unit;

FIG. 5A is a flowchart (A) illustrating a partial flow of allocation release processing in which a check is not performed for a chunk including metadata;

FIG. 5B is a flowchart (B) illustrating a partial flow of allocation release processing in which a check is not performed for a chunk including metadata;

FIG. 6A is a flowchart illustrating a partial flow of allocation release processing in which checks for data that are successive on a physical disk area is performed;

FIG. 6B is a flowchart illustrating a partial flow of allocation release processing in which checks for data that are successive on a physical disk area are performed;

FIG. 7A is a flowchart illustrating a partial flow of allocation release processing in which the allocation release processing illustrated in FIGS. 4, 6A, and 6B is also used;

FIG. 7B is a flowchart illustrating a partial flow of allocation release processing in which the allocation release processing illustrated in FIGS. 4, 6A, and 6B is also used;

FIG. 8A is a flowchart illustrating a partial flow of allocation release processing in which the allocation release processing illustrated in FIGS. 5B, 6A, and 6B is also used; and

FIG. 8B is a flowchart illustrating a partial flow of allocation release processing in which the allocation release processing illustrated in FIGS. 5B, 6A, and 6B is also used.

### DESCRIPTION OF EMBODIMENT

Preferred embodiment of the present invention will be explained with reference to accompanying drawings.

Note that this embodiment is not intended to limit the disclosed technique.

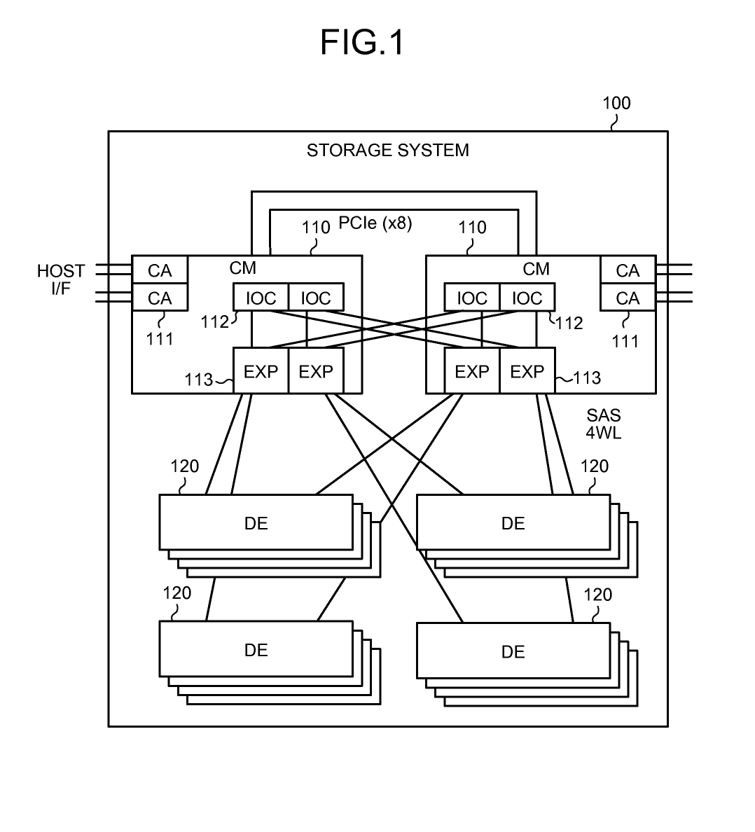

First, a configuration of a storage system according to the present embodiment will be described. FIG. 1 is a diagram illustrating a configuration of the storage system according to the embodiment. As illustrated in FIG. 1, a storage system 100 includes duplex CMs (Controller Module) 110 and DEs (Disk Enclosure) 120 divided into four groups.

The CMs 110 are modules that control the storage system 100, each of which includes two CAs (Channel Adapter) 111, two IOCs (Input Output Controller) 112, and two EXPs (EXPander) 113.

The CAs 111 are interfaces with a host that is an upper device. Here, the host is an information processing device such as a server. Write requests from the host are for writing data, initialization by writing zero's to whole of the volume, initialization of a block, and the like. The IOCs 112 are controllers for SAS (Serial Attached SCSI). The EXPs 113 connect the CMs 110 and the DEs 120 by 4WL (4 Wide Link) SAS. Here, 4WL means that four physical links are used for one SAS port. An 8-lane PCIe (PCI express) connects the duplex CMs 110.

Each of the DEs 120 is a device for storing disk devices on each of which a plurality of magnetic disks are mounted. Here, the storage system 100 including four groups each having the four DEs 120 is illustrated. However, the storage system 100 may have any number of DEs 120.

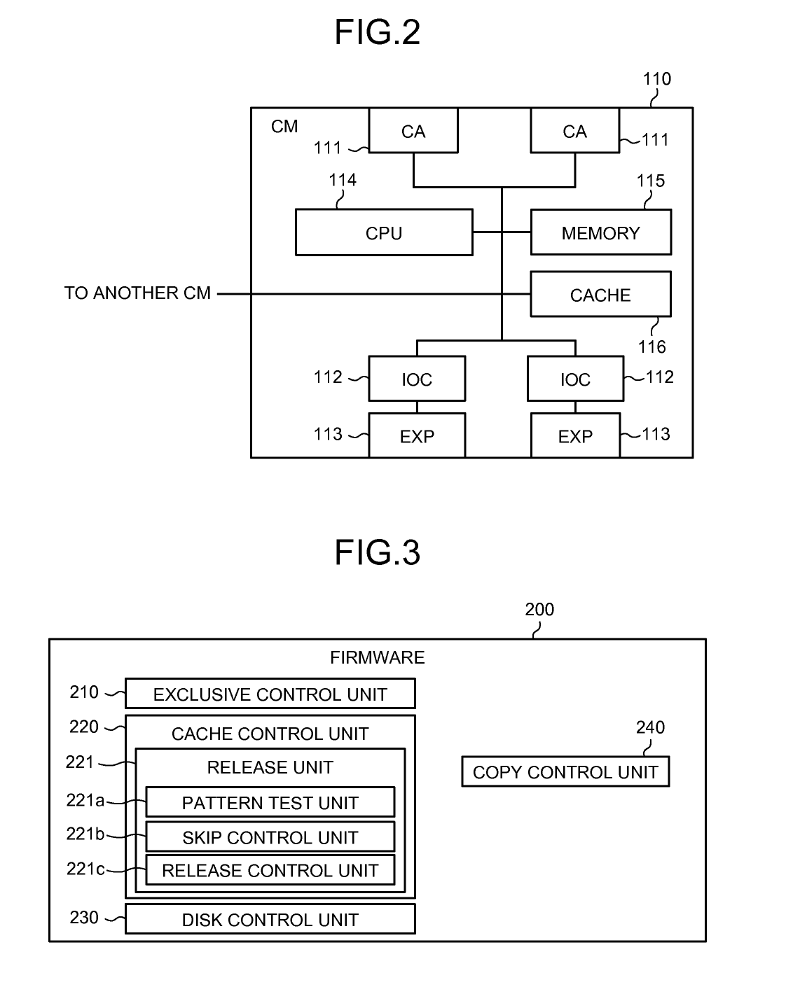

FIG. 2 is a diagram illustrating a hardware configuration of one of the CMs 110. As illustrated in FIG. 2, the CM 110 includes a CPU 114, a memory 115, and a cache 116 in addition to two of the CAs 111, two of the IOCs 112, and two of the EXPs 113.

The CPU 114 is an arithmetic unit that controls the storage system 100 by executing firmware. The memory 115 is a storage that stores firmware. The cache 116 is a storage that temporarily stores data read from/written to a magnetic disk.

FIG. 3 is a functional block diagram illustrating functions realized by executing firmware 200. As illustrated in FIG. 3, the CPU 114 realizes functions of an exclusive control unit 210, a cache control unit 220, a disk control unit 230, and a copy control unit 240.

The exclusive control unit 210 performs exclusive control of access to magnetic disks. For example, the exclusive control unit 210 controls such that data is not red from a magnetic disk to which data is being written.

The cache control unit 220 controls the cache 116. In addition, the cache control unit 220 has a management table for associating physical disk areas with logical areas to allocate a physical disk area to a logical area and release a physical area from a logical area.

The cache control unit 220 includes a release unit 221. The release unit 221 releases a physical disk area allocated to a chunk that has data of all zero among physical disk areas allocated to logical areas. This is because physical disk area allocation is not needed for a chunk of data pattern having data of all zero. However, the release unit 221 does not check whether data is all zero for all chunks, but identifies chunks for which a check is not needed and checks whether data is all zero for chunks other than the identified chunks.

Specifically, when a predetermined number of successive chunks have data that is not all zero, the release unit 221 skips a certain number of chunks and does not check whether data is all zero for the chunks being skipped.

The release unit 221 includes a pattern test unit 221a, a skip control unit 221b, and a release control unit 221c. The pattern test unit 221a tests whether each of chunks has data of all zero. The skip control unit 221b determines chunks as skip objects for which the pattern test unit 221a do not test and excludes the skip objects from test objects. The release control unit 221c releases allocation for chunks each having data of all zero among a plurality of chunks tested by the pattern test unit 221a.

When a host writes large data, for example, an area of successive long non-zero data may exist in a TPV. Taking into account the existence of such an area, when a predetermined number of successive chunks of non-zero data is detected, the release unit 221 skips a certain number of chunks because non-zero data is still expected for a while after the successive chunks. Because of the skip, the release unit 221 can reduce the number of checks and speeds up release processing. The number of chunks to be skipped depends on the size of a chunk and may be four assuming that the size of a chunk is twelve megabytes, for example.

The release unit 221 identifies a position of metadata used by an OS or a file system and does not check whether data is all zero for chunks to which metadata is written. Since the release unit 221 does not check chunks to which metadata is written, the number of checks can be reduced and release processing can be speeded up.

However, write position of metadata differs depending on an OS or a file system. File systems are mainly extent-based or block-based. In an extent-based file system, a meta-data area of about 10% of the volume size is mainly formed at the head part of the volume. On the other hand, in a block-based file system, metadata of about one megabyte is distributed to constant amounts of hundreds of kilobytes to tens of megabytes so as to be written at equal volume intervals.

Thus, the release unit 221 first identifies an OS and a file system. As a way of identification, a user may be caused to specify or the release unit 221 may read from the head physical block of a disk device. Then, the release unit 221 identifies the position of metadata based on the identified OS and file system.

As a way of reading an OS and a file system from the head physical block of a disk device, the release unit 221 may use an MBR (Master Boot Record) stored in the head physical block, for example. An MBR includes information regarding file system.

As described above, the release unit 221 identifies chunks for which a check whether data is all zero is not needed and then checks for chunks other than the identified chunks, whereby allocation release processing of physical disk areas can be performed effectively.

In the thin provisioning function, allocation of a preferable amount of a physical disk area is performed for each chunk of logical area when a host writes data. Because data written by a host is not necessarily successive on a logical area, successive data on a logical area of a TPV is not necessarily successive on a physical disk area. Thus, it is not optimal from a view point of disk access to check data sequentially on a logical area. Thus, the release unit 221 checks data sequentially on logical area and also checks data allocation part of another logical area that is successive on the physical disk area.

That is, when the release unit 221 checks a chunk, after checking the last physical block of the chunk, the release unit 221 checks a head physical block of a chunk that is adjacent to the chunk on the physical disk area. Then, when the release unit 221 detects non-zero data in the head physical block of the adjacent chunk, the release unit 221 stores information indicating that a check is completed for the chunk in a memory or the like to manage check status of the chunk and controls not to check for chunks that have been checked.

As described above, the release unit 221 checks head parts of chunks that are adjacent on a physical disk area at the same time in one disk access. Thus, overhead due to disk access can be reduced and allocation release processing of the physical disk area can be speeded up.

The disk control unit 230 controls reading of data from magnetic disks and writing of data to magnetic disks based on instructions from the cache control unit 220. The copy control unit 240 controls copy of data in the storage system 100.

Next, startup of allocation release processing by the release unit 221 will be described. The allocation release processing by the release unit 221 is performed manually or automatically. When it is performed automatically, the allocation release processing is started at a following timing.

(1) After Copy is Performed by a Copy Function of the Storage System 100

In the copy processing of the storage system 100, copy is performed in block level. Thus, upon copy of a volume of a certain disk device, data is written to a copy destination with zero data in any unused portion of the copy source volume. For this reason, there is a high possibility that a zero data area is generated in a copy destination TPV after copy processing. Therefore, it is effective to perform allocation release processing after copy processing is completed.

(2) After Sequential Write of LBA (Logical Block Address) to all Area of a TPV Upon all Restore or the Like.

When an unused area exists in a backup source volume, backup is performed with zero data in the area. Upon restore of this data, the zero data is written to a volume as is. To the storage system 100, all restore of a volume looks sequential write. Thus, when sequential write is performed on whole of a TPV, the release unit 221 determines that all restore has been performed and automatically performs allocation release processing. While data is being written, for example, the release unit 221 checks whether the first write is for the head LBA of a TPV, whether each of all LBAs to which data is written after the write of the head LBA is a logical area that is successive to a previous LBA, and whether the last write is for the last LBA of a TPV. When the all conditions are satisfied, the release unit 221 determines that sequential write has been performed on whole of a TPV.

(3) After Initialization of a TPV from the Host (Formation of File System or Formation of a Volume by a Volume Manager)

Similarly to (2), initialization processing from the host looks sequential write to the storage system 100. Thus, when sequential write is performed on whole of a TPV, the release unit 221 determines that all restore has been performed and automatically performs allocation release processing.

(4) When an alarm state is generated by monitoring an amount of a TPV (when an allocated volume reaches a threshold value with respect to a whole volume of the TPV) An alarm state is generated when a free space of a TPV is small. When one cause of reduction of a free space is allocation of zero data, use efficiency of the TPV can be improved by releasing zero-data area. In order to cope with such a case, the release unit 221 automatically performs allocation release processing when an alarm state is generated by monitoring an amount of a TPV.

(5) Periodical Timing Defined by Schedule Setting

Based on a schedule set by an administrator of the storage system 100, the release unit 221 automatically performs allocation release processing.

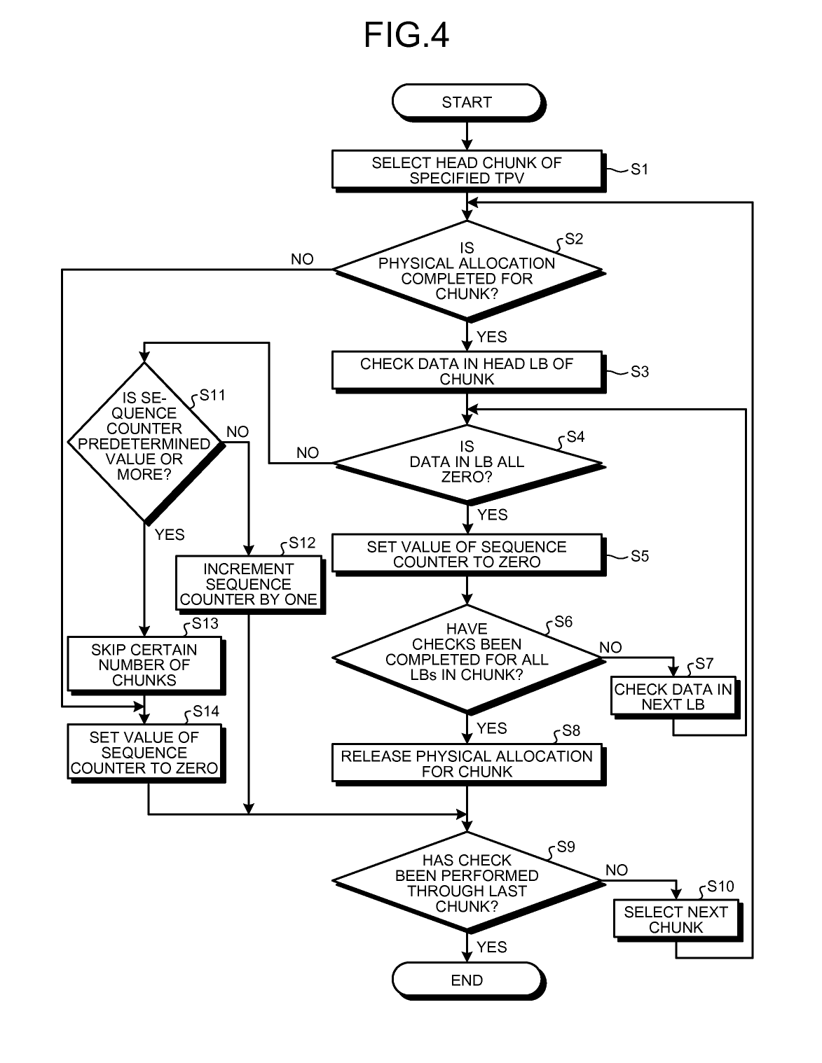

Next, a flow of allocation release processing by the release unit 221 will be described. FIG. 4 is a flowchart illustrating a flow of allocation release processing of the release unit 221. As illustrated in FIG. 4, the release unit 221 selects the head chunk of a TPV on which allocation release processing is specified to be performed (step S1), and determines whether physical allocation is completed for the selected chunk (step S2). Here, “physical allocation is completed” means that a physical disk area has been allocated.

When physical allocation is completed, the release unit 221 checks data in the head LB (Logical Block) of the chunk (step S3), and determines whether data in the LB is all zero (step S4). The size of an LB is 512 bytes.

When data in the LB is all zero as a result, the release unit 221 sets the value of a sequence counter to zero (step S5). Here, the sequence counter is a counter that counts the number of chunks that are not all zero and is initialized to zero because a chunk of all zero was found.

Then, the release unit 221 determines whether checks whether data is all zero have been completed for all LBs in the chunk (step S6). When the check is not completed for an LB, the release unit 221 checks data in a next LB (step S7) and returns to step S4. On the other hand, when checks have been completed for all LBs in the chunk, it means that data in the chunk is all zero, and thus the release unit 221 releases physical allocation for the chunk (step S8).

The release unit 221 then determines whether the check has been performed through the last chunk (step S9). And when the check has been performed through the last chunk, the release unit 221 ends the processing, and when the check has not been performed through the last chunk, the release unit 221 selects a next chunk (step S10) and returns to step S2.

On the other hand, when data in the LB is not all zero, the release unit 221 determines whether the value of the sequence counter is a predetermined value or more (step S11). When the value is not the predetermined value or more, the release unit 221 increments the sequence counter by one (step S12), and proceeds to step S9. The case where the value of the sequence counter is not the predetermined value or more is a case where chunks having data that is not all zero are not successive enough to allow for skip of checks for some chunks. On the other hand, when the value of the sequence counter is the predetermined value or more, the release unit 221 skips checks for a certain number of chunks (step S13), sets the value of the sequence counter to zero (step S14), and proceeds to step S9.

When physical allocation is not completed for the selected chunk, a check for the chunk is not needed. And since successive chunks having data of all zero end, the release unit 221 proceeds to step S14.

As described above, when a predetermined number of chunks having data that is not all zero are successive, the release unit 221 skips checks for some chunks. Thus, the number of checks for chunks can be reduced and allocation release processing can be speeded up.

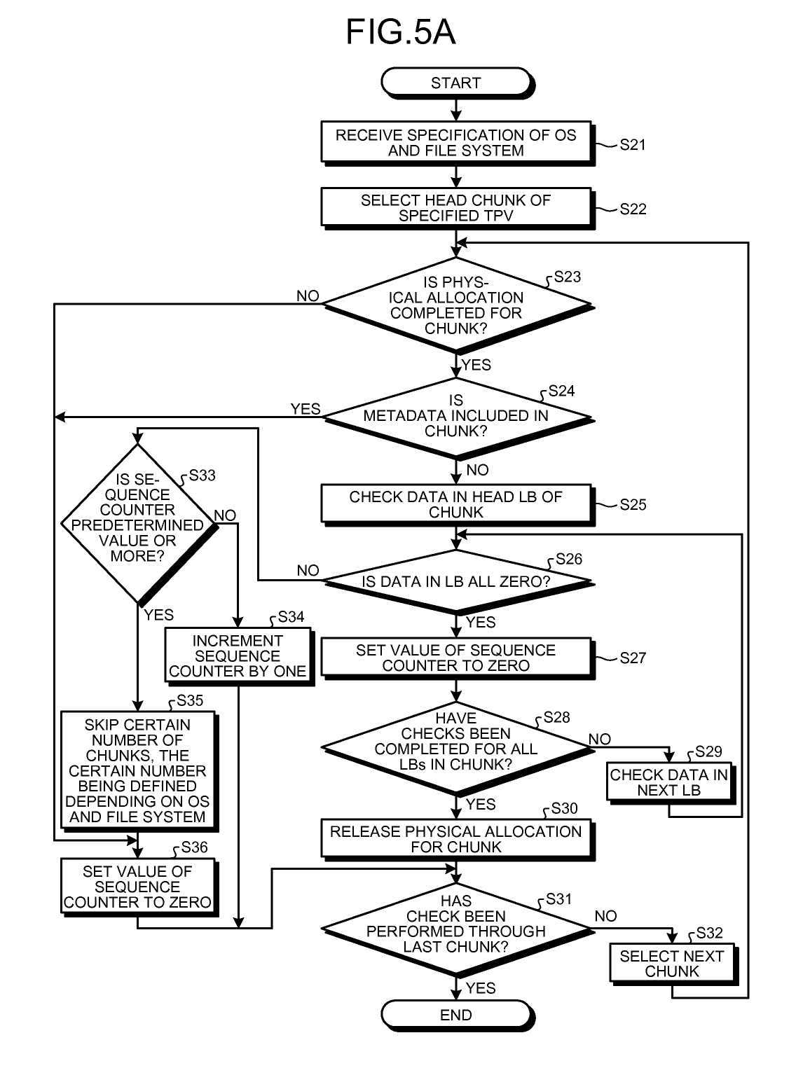

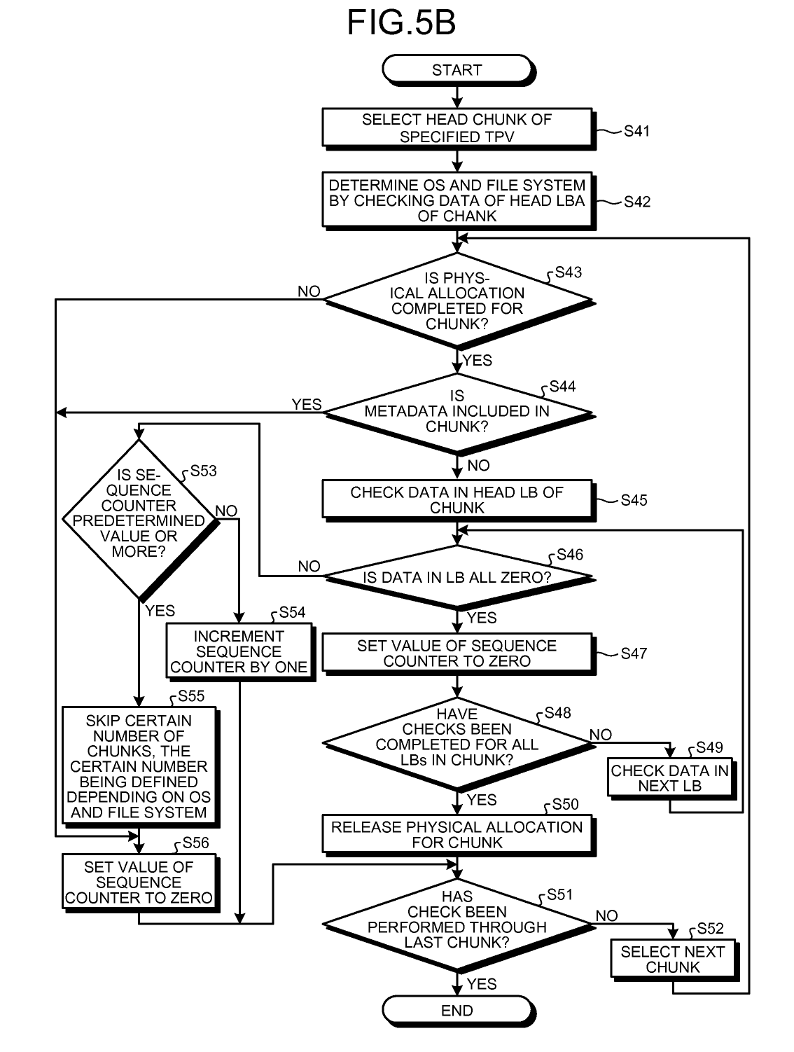

Next, a flow of allocation release processing in which a check is not performed for a chunk including metadata will be described. FIGS. 5A and 5B are flowcharts illustrating flows of allocation release processing in which a check is not performed for a chunk including metadata. FIG. 5A illustrates a case where specification of an OS and a file system is received from an administrator of the storage system 100, and FIG. 5B illustrates a case where the release unit 221 determines an OS and a file system.

As illustrated in FIG. 5A, the release unit 221 receives specification of an OS and a file system from an administrator (step S21). The release unit 221 selects the head chunk of a TPV on which allocation release processing is specified to be performed (step S22), and determines whether physical allocation is completed for the selected chunk (step S23).

When physical allocation is completed, the release unit 221 determines whether metadata is included in the chunk based on the OS and file system information (step S24). When metadata is not included in the chunk as a result, the release unit 221 checks data in the head LB of the chunk (step S25), and determines whether data in the LB is all zero (step S26).

When data in the LB is all zero as a result, the release unit 221 sets the value of the sequence counter to zero (step S27). Then, the release unit 221 determines whether checks whether data is all zero have been completed for all LBs in the chunk (step S28). When the check is not completed for an LB as a result, the release unit 221 checks data in a next LB (step S29), and returns to step S26.

On the other hand, when checks have been completed for all LBs in the chunk, it means that data in the chunk is all zero, and thus the release unit 221 releases physical allocation for the chunk (step S30). The release unit 221 then determines whether the check has been performed through the last chunk (step S31). And when the check has been performed through the last chunk, the release unit 221 ends the processing, and when the check has not been performed through the last chunk, the release unit 221 selects a next chunk (step S32) and returns to step S23.

On the other hand, when data in the LB is not all zero, the release unit 221 determines whether the value of the sequence counter is the predetermined value or more (step S33). When the value is not the predetermined value or more, the release unit 221 increments the sequence counter by one (step S34), and proceeds to step S31. On the other hand, when the value of the sequence counter is the predetermined value or more, the release unit 221 skips checks for a certain number of chunks, the number being defined depending on an OS and a file system (step S35), sets the value of the sequence counter to zero (step S36), and proceeds to step S31.

When physical allocation is not completed for the selected chunk and when metadata is included in the chunk, a check for the chunk is not needed. And since successive chunks having data of all zero end, the release unit 221 proceeds to step S36.

As illustrated in FIG. 5B, the release unit 221 selects the head chunk of a TPV on which allocation release processing is specified (step S41). The release unit 221 then determines an OS and a file system (step S42).

The release unit 221 then determines whether physical allocation is completed for the chunk (step S43). When physical allocation is completed, the release unit 221 determines whether metadata is included in the chunk based on the OS and file system information (step S44). When metadata is not included in the chunk as a result, the release unit 221 checks data in the head LB of the chunk (step S45), and determines whether data in the LB is all zero (step S46).

When data in the LB is all zero as a result, the release unit 221 sets the value of the sequence counter to zero (step S47). Then, the release unit 221 determines whether checks whether data is all zero have been completed for all LBs in the chunk (step S48). When the check is not completed for an LB as a result, the release unit 221 checks data in a next LB (step S49), and returns to step S46.

On the other hand, when checks have been completed for all LBs in the chunk, it means that data in the chunk is all zero, and thus the release unit 221 releases physical allocation for the chunk (step S50). The release unit 221 then determines whether the check has been performed through the last chunk (step S51). And when the check has been performed through the last chunk, the release unit 221 ends the processing, and when the check has not been performed through the last chunk, the release unit 221 selects a next chunk (step S52) and returns to step S43.

On the other hand, when data in the LB is not all zero, the release unit 221 determines whether the value of the sequence counter is the predetermined value or more (step S53). When the value is not the predetermined value or more, the release unit 221 increments the sequence counter by one (step S54), and proceeds to step S51. On the other hand, when the value of the sequence counter is the predetermined value or more, the release unit 221 skips checks for a certain number of chunks, the number being defined depending on an OS and a file system, (step S55), sets the value of the sequence counter to zero (step S56), and proceeds to step S51.

When physical allocation is not completed for the selected chunk and when metadata is included in the chunk, a check for the chunk is not needed. And since successive chunks having data of all zero end, the release unit 221 proceeds to step S56.

As described above, a check whether data is all zero is not performed for chunks in which metadata is included. Thus, the release unit 221 can reduce the number of checks for a chunk and speed up allocation release processing.

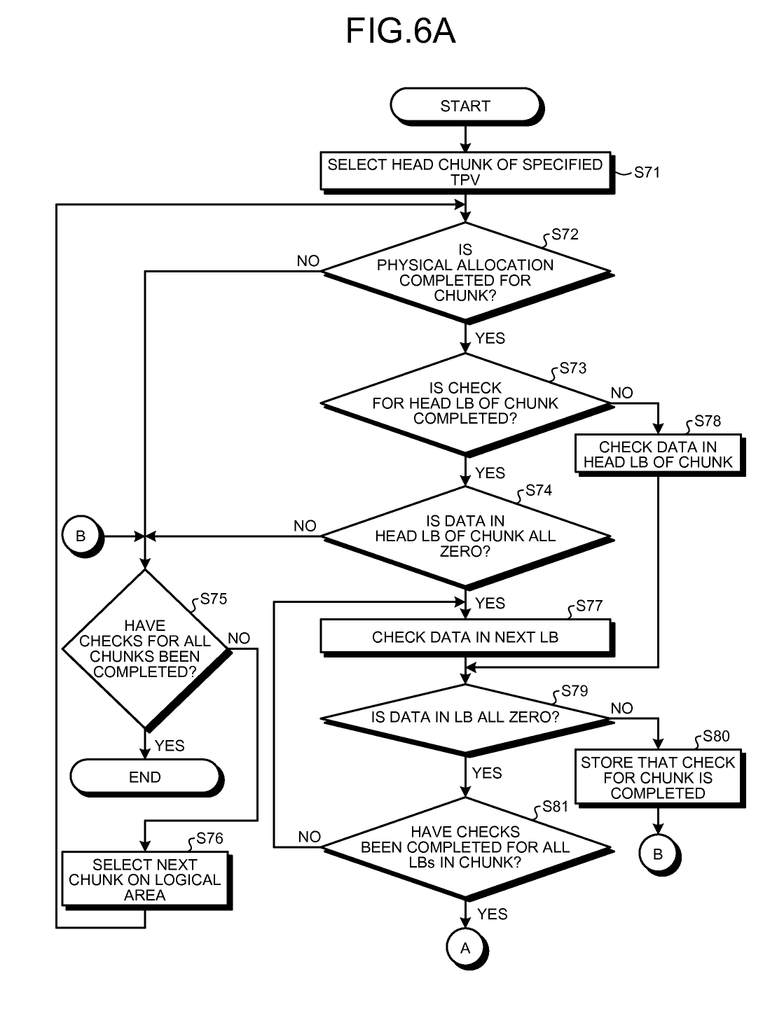

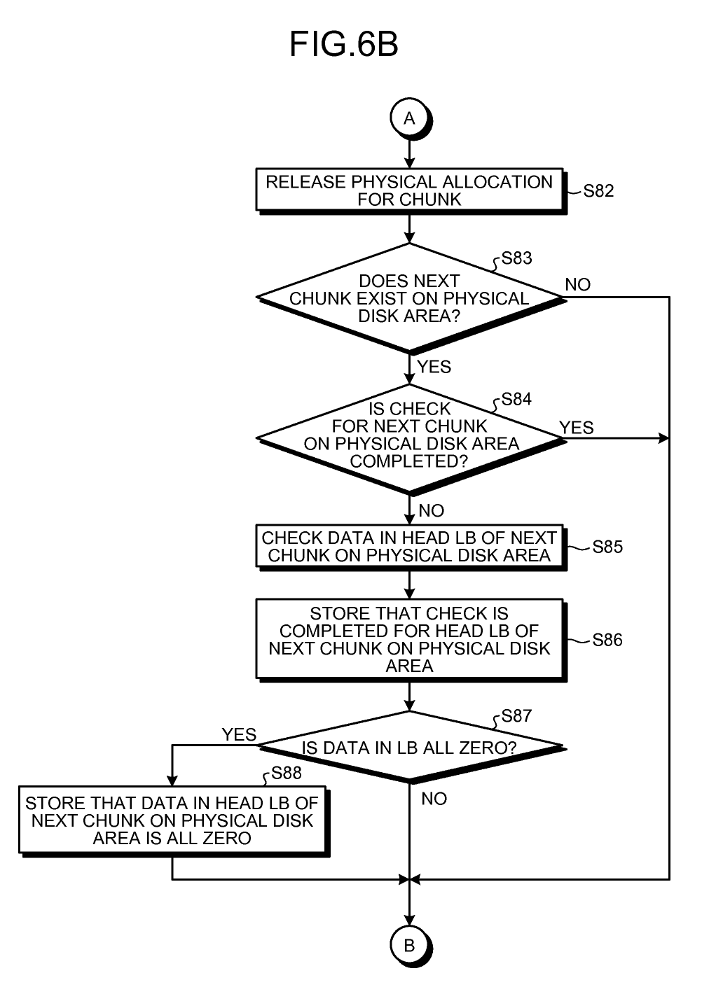

Next, a flow of allocation release processing in which checks for data that are successive on a physical disk area is performed will be described. FIGS. 6A and 6B are flowcharts illustrating a flow of allocation release processing in which checks for data that are successive on a physical disk area is performed.

As illustrated in FIG. 6A, the release unit 221 selects the head chunk of a TPV on which allocation release processing is specified to be performed (step S71), and determines whether physical allocation is completed for the selected chunk (step S72). When physical allocation is not completed as a result, the release unit 221 proceeds to step S75.

On the other hand, when physical allocation is completed, the release unit 221 determines whether a check for the head LB of the chunk is completed (step S73). Here, the case where the check is completed is a case where the check has been performed for the chunk because the chunk is successive on a physical disk area to a chunk for which a check had been performed.

When the check for the head LB of the chunk is completed, the release unit 221 determines whether data in the head LB of the chunk is all zero (step S74). When data in the head LB of the chunk is not all zero as a result, the release unit 221 determines whether checks for all chunks have been completed (step S75) and ends the processing when checks for all chunks have been completed. On the other hand, when a chunk for which a check is not performed exists, the release unit 221 selects a next chunk on the logical area (step S76) and returns to step S72.

When data in the head LB of the chunk is all zero, the release unit 221 checks data in a next LB (step S77) and determines whether data in the LB is all zero (step S79). When the check for the head LB of the chunk is not completed, the release unit 221 checks data in the head LB of the chunk (step S78), and determines whether data in the LB is all zero (step S79).

When data in the LB is not all zero as a result, the release unit 221 stores that a check for the chunk is completed (step S80) and proceeds to step S75. On the other hand, when data in the LB is all zero, the release unit 221 determines whether checks whether data is all zero have been completed for all LBs in the chunk (step S81). When the check is not completed for an LB as a result, the release unit 221 returns to step S77.

On the other hand, when checks have been completed for all LBs in the chunk, the release unit 221 releases physical allocation for the chunk as illustrated in FIG. 6B (step S82). The release unit 221 then determines whether a next chunk exists on the physical disk area (step S83) and moves to step S75 when a next chunk does not exist.

On the other hand, when a next chunk exists on the physical disk area, the release unit 221 checks a chunk being successive on the physical disk area. That is, the release unit 221 determines whether a check for a next chunk on the physical disk area is completed (step S84) and moves to step S75 when the check for a next chunk is completed. On the other hand, when the check is not completed, the release unit 221 checks data in the head LB of a next chunk on the physical disk area (step S85) and stores that a check is completed for the head LB of the next chunk on the physical disk area (step S86). The release unit 221 then determines whether data in the LB is all zero (step S87), and stores that the data in the head LB of a next chunk on the physical disk area is all zero when it determines that the data is all zero (step S88). The release unit 221 moves to step S75.

As described above, the release unit 221 checks chunks being successive on a physical disk area, and thus the frequency of disk access can be reduced and allocation release processing can be speeded up.

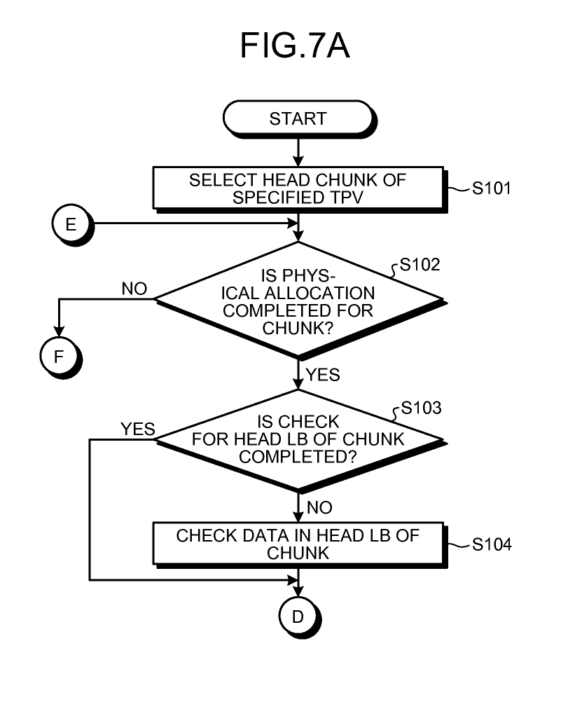

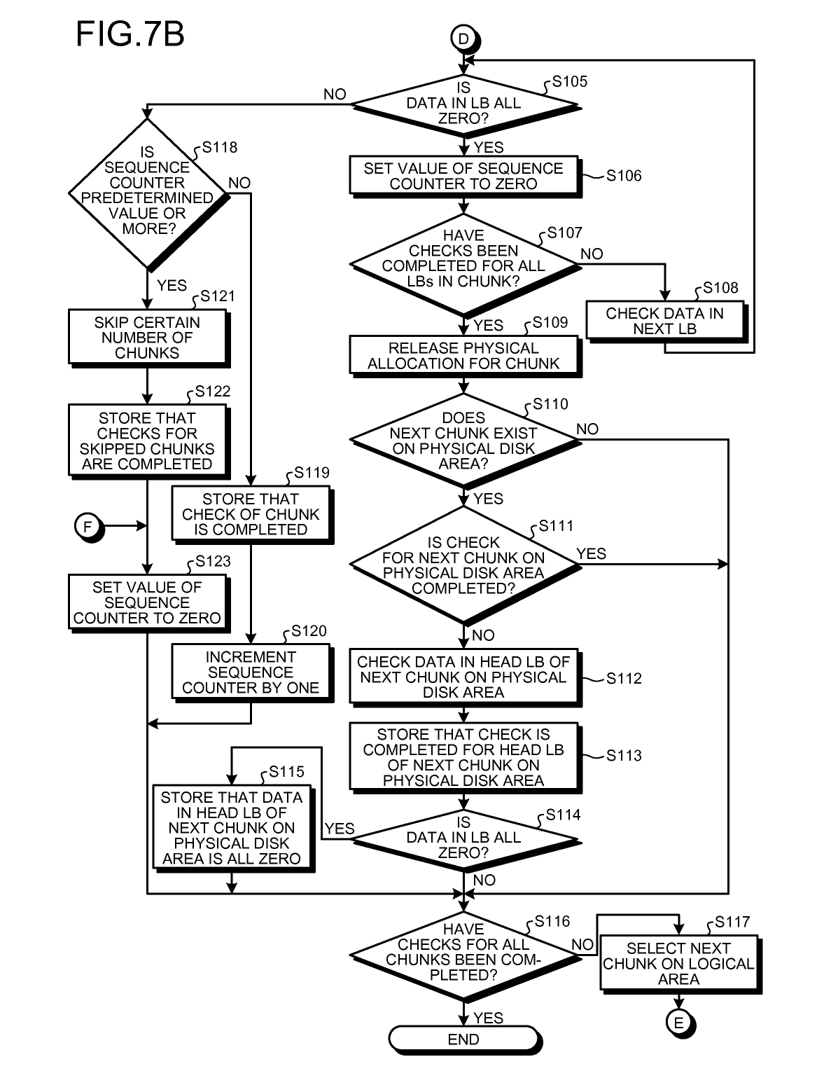

Next, a flow of allocation release processing in which the allocation release processing illustrated in FIGS. 4, 6A, and 6B is also used will be described. FIGS. 7A and 7B are flowcharts illustrating a flow of allocation release processing in which the allocation release processing illustrated in FIGS. 4, 6A, and 6B is also used.

As illustrated in FIG. 7A, the release unit 221 selects the head chunk of a TPV on which allocation release processing is specified to be performed (step S101), and determines whether physical allocation is completed for the selected chunk (step S102).

When physical allocation is not completed, the release unit 221 proceeds to step S123. On the other hand, when physical allocation is completed, the release unit 221 determines whether the head LB of the chunk is completed (step S103). When the check for the head LB of the chunk is not completed, the release unit 221 checks data in the head LB of the chunk (step S104).

The release unit 221 determines whether data in the LB is all zero as illustrated in FIG. 7B (step S105). When data in the LB is all zero as a result, the release unit 221 sets the value of the sequence counter to zero (step S106).

Then, the release unit 221 determines whether checks whether data is all zero have been completed for all LBs in the chunk (step S107). When a check is not completed for an LB, the release unit 221 checks data in a next LB (step S108). The release unit 221 then returns to step S105.

On the other hand, when checks have been completed for all LBs in the chunk, it means that data in the chunk is all zero, and thus the release unit 221 releases physical allocation for the chunk (step S109). The release unit 221 then determines whether a next chunk exists on the physical disk area (step S110) and moves to step S116 when a next chunk does not exist.

On the other hand, when a next chunk exists on the physical disk area, the release unit 221 checks a chunk being successive on the physical disk area. That is, the release unit 221 determines whether a check for a next chunk on the physical disk area is completed (step S111) and moves to step S116 when the check for the next chunk is completed. On the other hand, when the check is not completed, the release unit 221 checks data in the head LB of a next chunk on the physical disk area (step S112) and stores that a check the head LB of the next chunk on the physical disk area is completed (step S113). The release unit 221 then determines whether data in the LB is all zero (step S114), and stores that the data in the head LB of a next chunk on the physical disk area is all zero when it determines that the data is all zero (step S115).

The release unit 221 determines whether checks for all chunks have been completed (step S116) and ends the processing when checks for all chunks have been completed. On the other hand, when a chunk for which a check is not performed exists, the release unit 221 selects a next chunk on the logical area (step S117) and returns to step S102.

When data in the LB is not all zero, the release unit 221 determines whether the value of the sequence counter is the predetermined value or more (step S118). When the value is not the predetermined value or more, the release unit 221 stores that a check of the chunk is completed (step S119). The release unit 221 then increments the sequence counter by one (step S120) and proceeds to step S116. On the other hand, when the value of the sequence counter is the predetermined value or more, the release unit 221 skips checks for a certain number of chunks (step S121) and stores that checks for the skipped chunks are completed (step S122). The release unit 221 then sets the value of the sequence counter to zero (step S123) and proceeds to step S116.

As described above, the release unit 221 performing allocation release processing in which the allocation release processing illustrated in FIGS. 4, 6A, and 6B is also used can further speed up the allocation release processing comparing to a case where the allocation release processing illustrated in FIGS. 4, 6A, and 6B is not used.

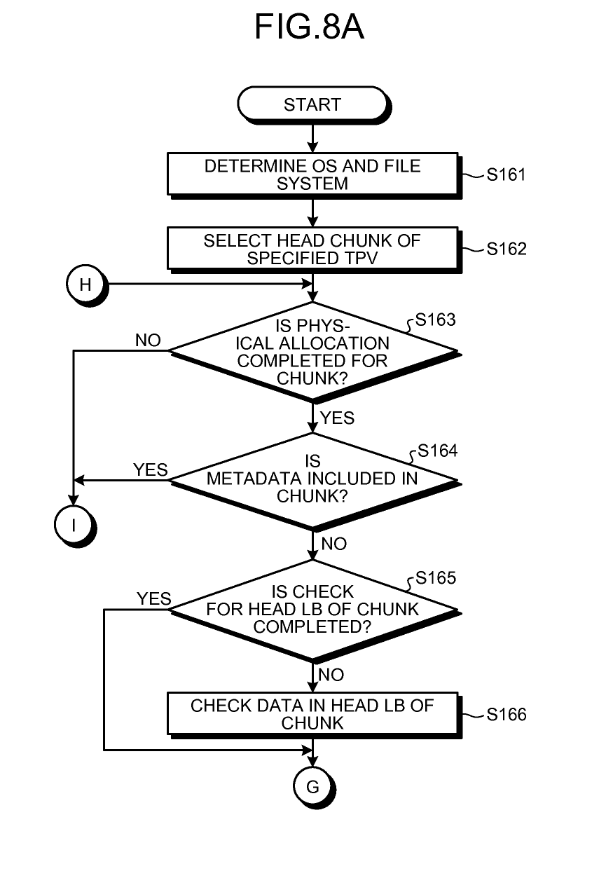

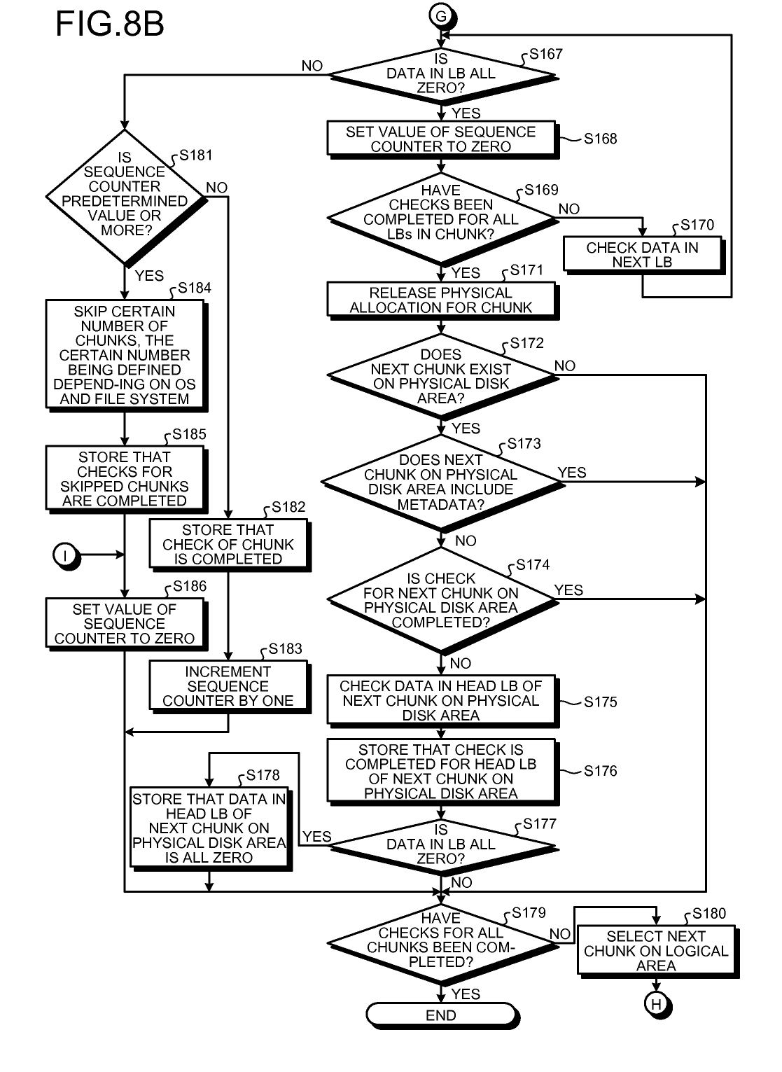

Next, a flow of allocation release processing in which the allocation release processing illustrated in FIGS. 5B, 6A, and 6B is also used will be described. FIGS. 8A and 8B are flowcharts illustrating a flow of allocation release processing in which the allocation release processing illustrated in FIGS. 5B, 6A, and 6B is also used.

As illustrated in FIG. 8A, the release unit 221 determines an OS and a file system (step S161). The release unit 221 selects the head chunk of a TPV on which allocation release processing is specified (step S162).

The release unit 221 then determines whether physical allocation is completed for the chunk (step S163) and proceeds to step S186 when physical allocation is not complete. On the other hand, when physical allocation is completed, the release unit 221 determines whether metadata is included in the chunk based on the OS and file system information (step S164).

When metadata is included in the chunk as a result, the release unit 221 proceeds to step S186. On the other hand, when metadata is not included in the chunk, the release unit 221 determines whether a check for the head LB of the chunk is completed (step S165). When the check is not completed, the release unit 221 checks data in the head LB of the chunk (step S166).

The release unit 221 determines whether data in the LB is all zero as illustrated in FIG. 8B (step S167). When data in the LB is all zero as a result, the release unit 221 sets the value of the sequence counter to zero (step S168).

Then, the release unit 221 determines whether checks whether data is all zero have been completed for all LBs in the chunk (step S169). When a check is not completed for an LB, the release unit 221 checks data in a next LB (step S170). The release unit 221 then returns to step S167.

On the other hand, when checks have been completed for all LBs in the chunk, it means that data in the chunk is all zero, and thus the release unit 221 releases physical allocation for the chunk (step S171). The release unit 221 then determines whether a next chunk exists on the physical disk area (step S172) and moves to step S179 when a next chunk does not exist.

On the other hand, when a next chunk exists on the physical disk area, the release unit 221 checks a chunk being successive on the physical disk area. That is, the release unit 221 checks whether a next chunk on the physical disk area includes metadata (step S173) and moves to step S179 when metadata is included. On the other hand, when metadata is not included, the release unit 221 determines whether a check for a next chunk on the physical disk area is completed (step S174) and moves to step S179 when the check is completed. On the other hand, when the check is not completed, the release unit 221 checks data in the head LB of a next chunk on the physical disk area (step S175) and stores that a check of the head LB of the next chunk on the physical disk area is completed (step S176). The release unit 221 then determines whether data in the LB is all zero (step S177), and stores that the data in the head LB of the next chunk on the physical disk area is all zero when it determines that the data is all zero (step S178).

The release unit 221 determines whether checks for all chunks have been completed (step S179) and ends the processing when checks for all chunks have been completed. On the other hand, when a chunk for which a check is not performed exists, the release unit 221 selects a next chunk on the logical area (step S180) and returns to step S163.

When data in the LB is not all zero, the release unit 221 determines whether the value of the sequence counter is the predetermined value or more (step S181). When the value is not the predetermined value or more, the release unit 221 stores that a check of the chunk is completed (step S182). The release unit 221 then increments the sequence counter by one (step S183) and proceeds to step S179. On the other hand, when the value of the sequence counter is the predetermined value or more, the release unit 221 skips checks for a certain number of chunks, the number being defined depending on an OS and a file system (step S184) and stores that checks for the skipped chunks are completed (step S185). The release unit 221 then sets the value of the sequence counter to zero (step S186) and proceeds to step S179.

As described above, the release unit 221 performing allocation release processing in which the allocation release processing illustrated in FIGS. 5B, 6A, and 6B is also used can further speed up the allocation release processing comparing to a case where the allocation release processing illustrated in FIGS. 5B, 6A, and 6B is not used.

As described above, when a predetermined number of chunks having data that is not all zero are successive, the release unit 221 skips checks for a certain number of chunks in the embodiment. Thus, checks for chunks can be reduced and allocation release processing can be speeded up.

In addition, in the embodiment, the release unit 221 identifies the position of metadata based on an OS and a file system and does not check for a chunk including metadata. Thus, checks for chunks can be reduced and allocation release processing can be speeded up.

Since in the embodiment, the release unit 221 checks chunks being successive on a physical disk area, the frequency of disk access can be reduced and allocation release processing can be speeded up.

In the embodiment, there is described a case where the position of metadata is identified based on an OS and a file system. However, the present invention is not limited thereto and is similarly applicable to a case where the position of metadata is identified based on an OS or a file system.

In addition, in the embodiment, a case where magnetic disks are used as storage media is described. However, the present invention is not limited thereto and is similarly applicable to a case where another storage medium such as a flash memory, for example, is used.

Further, in the embodiment, a case where a check whether data in an LB is all zero is performed is described. However, the present invention is not limited thereto and is similarly applicable to a case where a check whether data in an LB is another data pattern indicating that the LB is unused is performed.

In the embodiment, a plurality of types of allocation release processing is described. An administrator of the storage system 100 can specify a type of allocation release processing to be performed by the release unit 221. An administrator of the storage system 100 can also specify timing for automatically performing allocation release processing.

According to an embodiment, allocation release processing of a physical disk area can be performed effectively.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage device that allocates, to a plurality of logical storage areas to which write has been requested by an upper device, an unused physical storage area from a whole physical storage area constructed by one or more memory devices, the storage device comprising:
a pattern test unit that tests whether a data pattern written to each of the logical storage areas is a data pattern indicating that allocation of the physical storage area is needed;
a skip control unit that determines a skip object for which the pattern test unit does not perform the test among the logical storage areas being test objects of the pattern test unit, and excludes the skip object from the test objects; and
a release control unit that releases allocation of a physical storage area to a logical storage area, tested by the pattern test unit, to which the data pattern indicating that allocation of the physical storage area is not needed.

2. The storage device according to claim 1, wherein
the skip control unit determines more than one logical storage area that is successive to a predetermined number of successive logical storage areas to be skip objects when a data pattern written to the predetermined number of successive logical storage areas is a data pattern other than that indicating allocation of the physical storage areas is not needed as a result of the test by the pattern test unit.

3. The storage device according to claim 1 further comprising:
a type determination unit that determines a type of an operating system or a file system of the upper device, wherein
the skip control unit determines a logical storage area to be the skip object based on the type determined by the type determination unit.

4. The storage device according to claim 1, wherein
the pattern test unit tests a head logical storage area in all of the logical storage areas constructing a logical volume that the upper device is allowed to use, and
the skip control unit determines a logical storage area to be the skip object based on a test result of the head logical storage area.

5. The storage device according to claim 1, wherein
the release control unit causes the pattern test unit to test a next logical storage area on the physical storage area upon release of the allocation, and
the skip control unit determines the logical storage area for which information that a test is completed is stored as a skip object.

6. The storage device according to claim 1, further comprising:
a copy unit that copies data in the device, wherein
the skip control unit determines a logical storage area to be a skip object for which the test of the pattern test unit is not performed after the copy unit copies.

7. The storage device according to claim 1, further comprising:
a determination unit that determines whether sequential write has been performed for all of the logical storage areas constructing a logical volume that the upper device is allowed to use, wherein
the skip control unit determines a logical storage area to be a skip object for which the test of the pattern test unit is not performed when the determination unit determines that sequential write is performed for all of the logical storage areas.

8. The storage device according to claim 1, further comprising:
a monitoring unit that monitors an amount of a physical storage area that is allocated to the plurality of logical storage areas constructing a logical volume that the upper device is allowed to use, wherein
the skip control unit determines a logical storage area to be a skip object for which the test of the pattern test unit is not performed when an amount of a physical storage area monitored by the monitoring unit reaches a predetermined threshold.

9. An allocation release control method performed by a computer, the method comprising:
allocating, to a plurality of logical storage areas to which write has been requested by an upper device, an unused physical storage area from a whole physical storage area constructed by one or more memory devices;
performing a test whether a data pattern written to each of the logical storage areas is a data pattern indicating that allocation of the physical storage area is needed, after determining a skip object for which the test is not performed, while excluding the logical storage area that has been determined to be a skip object; and
releasing allocation of a physical storage area, tested by the performing, to a logical storage area to which the data pattern indicating that allocation of the physical storage area is not needed.

10. A computer-readable recording medium having stored therein a program causing a computer to execute a process comprising:
allocating, to a plurality of logical storage areas to which write has been requested by an upper device, an unused physical storage area from a whole physical storage area constructed by one or more memory devices;
performing a test whether a data pattern written to each of the logical storage areas is a data pattern indicating that allocation of the physical storage area is needed, after determining a logical storage area to be a skip object for which the test is not performed, while excluding the logical storage area that has been determined to be a skip object; and
releasing allocation of a physical storage area, tested by the performing, to a logical storage area to which the data pattern indicating that allocation of the physical storage area is not needed.
